(19) United States
(12) Patent Application Publication
(10) Pub. No.: US 2003/0095313 A1
(43) Pub. Date: May 22, 2003

(54) Methods and apparatus for higher-order compensation of transmission distortions in optical transmission media

(75) Inventors: Arthur Menikoff, Harvard, MA (US); James D. Targove, Sudbury, MA (US); Steven J. Wein, Sudbury, MA (US)

Correspondence Address: TESTA, HURWITZ & THIBEAULT, LLP, HIGH STREET TOWER, 125 HIGH STREET, BOSTON, MA, 02110, US

(73) Assignee: Terapulse, Inc., Acton, MA

(21) Appl. No.: 10/259,171

(22) Filed: Sep. 27, 2002

Related U.S. Application Data
(60) Provisional application No. 60/325,422, filed on Sep. 27, 2001.

(51) Int. Cl. H04B 10/00

(52) U.S. Cl. 359/161; 359/156

(57) ABSTRACT

Methods and apparatus for correcting polarization mode dispersion (PMD) and other transmission distortions in a light signal. By performing measurements of polarization state versus frequency on an intrachannel basis, the first-order and higher-order variations in the polarization state in the channel due to distortions such as PMD may be identified and characterized. Having identified and characterized the variations, the effects of the distortion may be compensated for and substantially eliminated. The methods and apparatus are not limited to single channel configurations but, instead, embrace configuration such as DWDM that carry a plurality of communication channels over a single fiber link.

### CROSS-REFERENCE TO RELATED APPLICATIONS

The present application claims the benefit of co-pending U.S. Provisional Application No. 60/325,422, filed on Sep. 27, 2001, the entire disclosure of which is incorporated by reference as if set forth in its entirety herein.

### FIELD OF THE INVENTION

The invention relates to the field of optical compensation systems and, in particular, to apparatus and methods for compensating for transmission distortions, such as polarization mode dispersion (PMD), in optical transmission media.

### BACKGROUND OF THE INVENTION

All optical media suffer to a greater or lesser degree from a polarization-dependent velocity of light, or birefringence. Polarization mode dispersion arises from the birefringence of the transmission medium of an optical transmission system. Birefringence is present in transmission media made of even so called “single-mode” optical fiber because of fiber imperfections and asymmetric stresses that result in a noncircular fiber core. An ideal single-mode optical fiber has a circular core, i.e., the core is isotropic and without eccentricity. Such an ideal fiber is isotropic, that is, the refractive index of the fiber is independent of the orientation of the electric field or, equivalently, the polarization of the light. Anisotropy (e.g., eccentricity) in an optical fiber core leads to birefringence and, therefore, different polarizations of light propagate through the optical fiber at different velocities.

This phenomenon, known as birefringence, may occur in optical fibers as the fiber's core becomes eccentric due to manufacture, stress, vibration, or some combination thereof. An ideal optical fiber is isotropic and without eccentricity, and therefore non-birefringent. The ideal fiber's refractive index is independent of the polarization of the light it carries or, equivalently, the orientation of the electric field as the light propagates through the fiber.

Light propagation in a single-mode fiber is governed by two fundamental or “principal” modes which, in an ideal fiber, are degenerate (i.e., indistinguishable). These modes are known as “principal states of polarization” (“PSPs”). Anisotropy in a fiber (e.g., eccentricity) leads to birefringence and, therefore, loss of degeneracy of the two principal modes. As a result, the principal modes of a light carried by an anisotropic fiber travel at different speeds and separate into two slightly displaced pulses. This spreading causes adjacent pulses in a data stream to overlap, resulting in data ambiguity or loss-a condition known as “polarization mode dispersion” (PMD). The spread between the two PSPs in an anisotropic fiber is known as the “differential group delay” (DGD) of the fiber.

Correcting for PMD and other transmission distortion effects in a fiber requires accurate measurements of the polarization properties of the light carried by the fiber. Current approaches to measurement may be electronic or optical in nature. Typically, optical measurement methods either require control of the light source, or only provide qualitative measurements of PMD properties. One exemplary method provides degree of polarization (DOP) measurements, which may subsequently be used with an iterative PMD correction algorithm.

The problem of correcting for PMD and other transmission distortion effects is complicated in dense wavelength-division multiplexing (DWDM) systems, which transmit a multitude of wavelength channels through a single optical fiber, because the DGD and PSPs of an optical fiber typically vary with frequency. Compensation using a first-order PMD approximation typically assumes a channel's DGD value and PSPs are independent of frequency, which may be adequate for certain applications. However, modulation formats with broad frequency spectra, or signals having higher data rates—e.g., 40 Gbits/sec or greater—typically demonstrate a PSP variation, a DGD variation, or both across the modulation bandwidth of a single channel that is too large to be ignored by using a first-order approximation.

Therefore, there is a need for techniques that provide direct measurements of polarization parameters without source control, allowing PMD and other transmission effects to be corrected in a single operation. Moreover, these techniques should be capable of characterizing and correcting the higher-order, i.e. frequency-dependent, PMD effects in a fiber link.

### SUMMARY OF THE INVENTION

The present invention relates to methods and apparatus for correcting PMD and other transmission distortions in a light signal. In accord with the present invention, the first and higher order variations in the state of polarization may be measured versus frequency on an intrachannel basis. Having measured the variation, the effects of the distortion may be compensated for and substantially eliminated. The methods and apparatus are not limited to single channel configurations but, instead, embrace configurations such as DWDM that carry a plurality of communication channels over a single fiber link.

In one aspect, the present invention relates to a method for correcting for PMD in a light signal having at least one communication channel. The polarization states of the light signal at a plurality of frequency subbands in the communication channel are determined and then used to determine a characteristic PMD vector. A characteristic DGD is determined and used to determine at least two compensation settings which, when applied to the light signal, renders the polarization states of the light signal across the plurality of frequency subbands in the communication channel substantially equal. The determined polarization states may be, for example, Stokes vectors or Jones vectors. Additionally, the determined compensation settings may be applied to the light signal using a corresponding number of compensation stages.

In one embodiment, determining the characteristic PMD vector includes constructing a set of vectors from the determined polarization states. The vectors may themselves be used to construct a set of frequency-dependent PMD vectors. The PMD vectors may be used to determine the characteristic PMD vector. In one embodiment, the characteristic PMD vector substantially satisfies a least-squares fit to the determined set of frequency-dependent PMD vectors.

In one embodiment, a second-order fit to the determined polarization states of the light as a function of frequency is used to determine the characteristic DGD. In another embodiment, the magnitude of the characteristic PMD vector is used to determine the DGD.

In another embodiment, the determination of compensator settings involves the selection of a target polarization state value and the selection of compensation settings such that, when the compensator settings are applied to the light signal, the difference between the selected target polarization state value and the polarization states of the light across the plurality of frequency subbands in the communication channel is substantially reduced. The selected target polarization state may be, for example, the polarization state value at the band center frequency. The magnitude of at least one of the compensator settings may vary in magnitude.

In still another embodiment, the determination of compensator settings involves retrieving at least one compensator setting using the characteristic DGD and the characteristic PMD vector from a memory storing predetermined compensator settings. Additionally, the retrieved compensation initial compensation settings may be used as an input to an optimization routine and the result of the optimization routine may be used as a compensation setting. Typical optimization routines include, but are not limited to, the Levenberg-Marquardt algorithm. In one embodiment, the step of applying the determined compensation settings to the light signal involves the computation of rotation Mueller matrices for polarization controllers that correspond to the determined compensator settings. As mentioned above, the method may be applied to a plurality of communication channels in the light signal at substantially the same time.

In another aspect, the present invention relates to an apparatus for correcting for PMD in a light signal having at least one communication channel. The apparatus includes a polarization state detector and two compensators. The polarization state detector receives the light signal and provides polarization state measurements of the light signal at a plurality of frequency subbands in the communication channel. One compensator receives the light signal and imposes a first DGD on it, after which the other compensator receives the light signal and imposes a second DGD on it. The magnitudes and orientations of the DGDs of the two compensators are determined from the polarization state measurements so as to reduce the PMD effects on the light signal.

In one embodiment, at least one of the compensators includes a plurality of polarization controllers, each of which is associated with a particular communication channel. In another embodiment, at least one of the compensators further includes a demultiplexer and a multiplexer, both in series with the polarization controllers, and a common delay line in series with the multiplexer. Suitable common delay lines include, but are not limited to, a polarization-maintaining fiber, a free space delay with a pair of polarizing beam splitters and a pair of mirrors, and a pair of collimators with a birefringent crystal situated therebetween.

The foregoing and other features and advantages of the present invention will be made more apparent from the description, drawings, and claims that follow.

### BRIEF DESCRIPTION OF THE DRAWINGS

The advantages of the invention may be better understood by referring to the following description taken in conjunction with the accompanying drawings in which:

FIG. 1 presents a flowchart of a method for PMD compensation in accord with the present invention;

FIG. 2 shows a Poincaré sphere representation of a PMD vector and the PSPs of an optical transmission system;

FIG. 3 is a projection above a Poincaré sphere of both the uncompensated polarization state measurements and the effects of first-order and higher-order compensation as functions of frequency in accord with the present invention; and

FIG. 4 presents an embodiment of an apparatus for higher-order PMD compensation in accord with the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

In brief overview, the present invention determines the polarization properties of one or more subbands in one or more communication channels in a fiber link. These properties may be characterized, for example, as Stokes or Jones vectors whose parameters vary as a function of frequency. Using these measured properties, the present invention corrects for higher-order, i.e. frequency-dependent, PMD effects in the channels. The methods and apparatus of the present invention are readily applied to single-channel or multi-channel transmission systems. In the latter case, embodiments of the present invention may measure and provide compensation in multiple channels simultaneously.

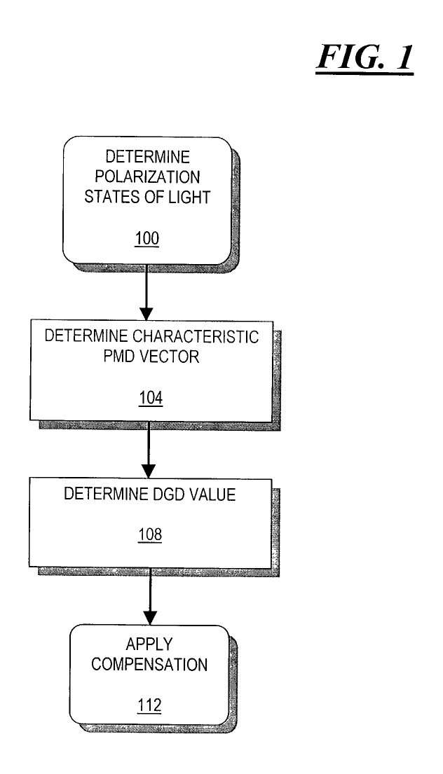

As illustrated in FIG. 1, one embodiment of a method for PMD compensation in an optical transmission medium in accord with the present invention begins by determining the polarization state of the incident light across various frequency subbands in the communication channel (Step 100). Next, with these measurements, a PMD vector is computed that characterizes the PMD behavior of the optical channel over the measured frequency range (Step 104). Having obtained a characteristic PMD vector, a DGD value is derived that characterizes the DGD behavior of the channel over the measured frequency range (Step 108). This information permits higher-order PMD compensation that renders the measured polarization states substantially equal to a desired polarization state. The compensation process (Step 112) involves the determination of one or more PMD compensation settings for a corresponding number of compensation stages present in the system, and the subsequent configuration of the stages to implement the PMD compensation settings.

In the compensation process, the incident light received for measurement is typically delivered through an optical medium such as a fiber core or free space, and typically includes one or more communication channels. Each communication channel ordinarily spans a separate frequency band including several individual-frequency subbands, with guard bands present between channels in some embodiments.

In one embodiment, the polarization state measurements (Step 100) are performed using a multi-channel spectral polarimeter. One such polarimeter is described in the pending U.S. patent application Ser. No. 10/218,681, the entire disclosure of which is incorporated by reference as if set forth in its entirety herein. In another embodiment, these measurements are performed by a plurality of single-channel polarimeters arranged in an array configuration to the same end. In still another embodiment, these measurements are performed by one single-channel polarimeter in series with at least one tunable filter to permit the selection of frequencies for measurement. The polarimeter measurements are taken across several subbands and may span one communication channel or several channels, depending on one or more of the band size and the end limits of the measurement band relative to the frequency bands allocated to each individual communication channel.

The measurements of polarization state are typically expressed using one or more conventional formalisms, such as Stokes vectors. A Stokes vector is a column vector having four entries that describe a polarization state. These entries are computed from the intensity of the incident light as if it had passed through various polarizing devices, namely a 50 percent transmitting filter (defined to be I₀), a perfect horizontal linear polarizer (defined to be I₁), a perfect linear polarizer with its transmission axis at 45 degrees from the horizontal axis (defined to be I₂), and a perfect right circular polarization filter (defined to be I₃). Then, the vector S may be expressed as:

$$S = [ \begin{matrix}{S}_{0} \\ {S}_{1} \\ {S}_{2} \\ {S}_{3}\end{matrix} ] = \begin{matrix}2 {I}_{0} \\ 2 {I}_{1} - 2 {I}_{0} \\ 2 {I}_{2} - 2 {I}_{0} \\ 2 {I}_{3} - 2 {I}_{0}\end{matrix} \qquad ( Eq . 1 )$$

The individual Stokes parameters Sᵢ also have their own physical significance. S₀ is the total intensity and is typically normalized to one. The parameters S₁ through S₃ measure the degree of horizontal linear polarization versus vertical linear polarization, +45 degrees linear polarization versus −45 degrees linear polarization, and left circular polarization versus right circular polarization, respectively.

The polarization state measurements may be expressed using other formalisms for polarization state data, such as Jones vectors. The present discussion assumes the use of Stokes vectors to represent polarization state measurements for simplicity's sake, although it is clear that the scope of the present invention encompasses any formalism for the expression of polarization state data.

The result of the measurement step (Step 100) is a set of polarization state measurements, Sᵢ(ω), where each individual measurement is associated with a different frequency or frequency band in the incident light. The resultant frequency sampling is a function of the detector pitch and dispersion for a spatially dispersive polarimeter, while the sampling for an actively scanned polarimeter is a function of the filter bandwidth and the filter spectral increment between measurements. For example, a 25-micron detector pitch and a spectral dispersion of 200 GHz/mm results in a spectral sampling of 5 GHz across each detector.

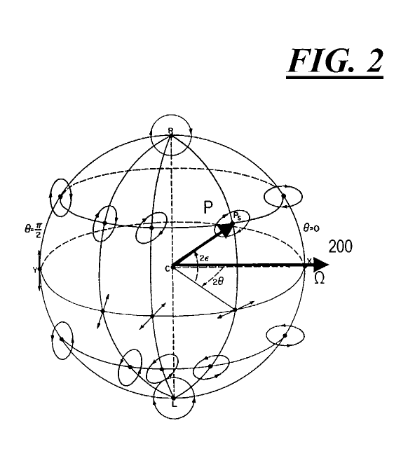

Each polarization state measurement may be conveniently represented as a Stokes vector S, which may be plotted as a point on the surface of a Poincaré sphere. Referring to FIG. 2, a Poincaré sphere is a convenient way to represent the set of all possible elliptical polarization states. A given latitude on the sphere represents a given ellipticity, with linear polarization at the equator and circular polarization at the poles. The “handedness” of the polarization changes between the hemispheres, with right-handed polarization in the upper hemisphere and left-handed polarization in the lower hemisphere. One degree of longitude on the sphere represents 0.5 degrees of physical rotation and, in addition, each longitude represents a fixed azimuth for the semi-major axis of the ellipse defined by the light's electric field vector E.

On the Poincaré sphere of FIG. 2, the system's PMD is defined to be Ω: a vector beginning at the sphere's origin, aligned in orientation with one of the PSPs of the system, and having a magnitude equal to one-half of the channel's DGD. In the first-order PMD approximation, the polarization measurements, plotted as points on the sphere, trace a circular arc on the Poincaré sphere.

A given input polarization state, P, appears as a vector sharing the sphere's origin with Ω, but oriented in a different direction. P is a linear combination of the PSPs of the system, and the relative intensity of each component is given by cos² (2θ) and sin² (2θ), respectively, with 2θ being the angle on the Poincaré sphere between P and Ω. If the input polarization vector falls in the direction of the PMD vector, i.e., P and Ω are aligned, then the energy in the incident light is concentrated in one PSP and, assuming a first-order approximation, there is no PMD spreading.

The vector Ω is constant in magnitude and orientation, in the first-order PMD approximation. However, the PMD of the channel—and therefore the channel DGD and PSPs—is typically frequency-dependent. On the Poincaré sphere of FIG. 2, the variation in DGD with frequency appears as a variation in the length of the PMD vector Ω with frequency. Likewise, the variation in PSPs with frequency manifests itself as a variation in the orientation of the Ω vector with frequency.

With a set of measurements (e.g., Stokes vectors P) characterizing the polarization states of the incident light across various subband frequencies in the channel (defined to be Sᵢ(ω)), the next step is to determine a PMD vector that characterizes the frequency-dependent PMD behavior of the channel over the measured frequency range (Step 104). The following discussion presents one method for determining this vector, although it is to be understood that the scope of the present invention encompasses all methods that determine a characteristic PMD vector from the polarization state data by, for example, constructing a characteristic vector that minimizes or maximizes one or more criteria using the polarization state data.

In one embodiment, a set of precession vectors, ΔSᵢ, is computed using the set of polarization state measurements Sᵢ(ω) by computing the vector difference between successive polarization state measurements, i.e., ΔSᵢ=Sᵢ₊₁−Sᵢ. By assuming that the channel PMD is invariant over the frequency ranges spanned by each individual precession vector ΔSᵢ, a PMD vector, Ωᵢ, may be determined from each precession vector ΔSᵢ such that the PMD vector corresponds to the precession over each frequency interval. The desired PMD vector Ωᵢ is normal to its corresponding precession vector such that:

\vec{Ω}ᵢ·\vec{ΔSᵢ}=0 (Eq. 2)

With a set of PMD vectors Ωᵢ derived from the measured polarization states Sᵢ(ω), a PMD vector Ω_{fit} may be determined that characterizes the PMD vectors across the spectral channel under consideration (Step 104). For example, the PMD vector Ω_{fit} may satisfy one or more specified optimization criteria. In one embodiment, the PMD vector Ω_{fit} is the least-squares fit to the polarization measurements Sᵢ(ω):

$${{Ω}^{->}}_{fit} = {Ω}^{->} ∋ {min}_{{Ω}^{->}} {\sum }_{i} {\vert {{Ω}^{->}}_{i} \cdot \vec{Δ {S}_{i}} \vert}^{2} \qquad ( Eq . 3 )$$

This least-squares fit may be implemented in hardware or software using conventional computational algorithms. In one embodiment, the least-squares fitting process is implemented as the solution to an eigenvalue problem. Then, the precession around the PMD vector with frequency is formed into a rotation matrix Ω and the differential Stokes vector between measurements is formed into a column vector ΔS:

$$\begin{matrix}{\sum }_{i} {\vert {{Ω}^{->}}_{i} \cdot \vec{Δ {S}_{i}} \vert}^{2} = {\sum }_{i} ( {Ω}^{T} Δ S ) \cdot ( Δ {S}^{T} Ω ) \\ = {Ω}^{T} [ {\sum }_{i} ( Δ S Δ {S}^{T} ) ] Ω \end{matrix} \qquad ( Eq . 4 )$$

As Ω^{T}ΔS=cos θ, where θ is the angle between the PMD vector and the vector ΔSᵢ, this sum is a measure of the perpendicularity between the PMD vector Ω and the differential segments:

$${\sum }_{i} {\vert {{Ω}^{->}}_{i} \cdot \vec{Δ {S}_{i}} \vert}^{2} = {\sum }_{i} ( {Ω}^{T} Δ S ) \cdot ( Δ {S}^{T} Ω ) = \sum {cos}^{2} {θ}_{i} \qquad ( Eq . 5 )$$

Defining:

$$A ≡ {\sum }_{i} ( Δ S {ΔS}^{T} ) \qquad ( Eq . 6 )$$

the optimization problem becomes:

$${Ω}_{fit} = Ω ∋ [ {min}_{Ω} ( {Ω}^{T} A Ω ) = {min}_{ Ω} {\sum }_{i} {cos}^{2} {θ}_{i} ] \qquad ( Eq . 7 )$$

This result of this optimization calculation is a PMD vector Ω_{fit} that is optimally orthogonal to the differential segments ΔSᵢ. By defining S_{Z} as the normalized eigenvector of A that corresponds to the smallest eigenvalue of A, the characteristic PMD vector may be related to the channel's DGD such that:

Ω_{fit}=τ·S_{z} (Eq. 8)

where τ is the DGD.

Having determined the characteristic PMD vector Ω_{fit}, a first-order PMD compensator may be set to provide substantially optimal first-order compensation across the corresponding frequency channel. These techniques are discussed in greater detail in pending U.S. patent application Ser. No. 10/101,427, the entire disclosure of which is incorporated by reference as if set forth in its entirety herein.

The next step in the process is to derive the value of the DGD value characterizing the link (Step 108). In one embodiment, this is accomplished by fitting a second-order polynomial to the polarization state data from the measurement step. Selecting a bias term A, the desired polynomial expression is:

S(ω)=A+Bω+Cω²+residuum (Eq. 9)

In one embodiment, the bias term A is an estimate of the polarization state at the band center frequency S₀. This estimate may be expressed, for example, as a Stokes vector.

Using this polynomial fit, the DGD of the channel is modeled as a function of frequency by projecting the trajectory of S(ω) onto a plane that is perpendicular to S_{Z}. The angular velocity of the projected trajectory in this plane is an instantaneous higher-order measure of the DGD as a function of frequency. Given the rotation angle in this plane, θ(ω), then the DGD τ is approximated by the slope of the best-fit angle velocity:

θ=τω+C+residuum (Eq. 10)

Using this information permits higher-order PMD compensation to be applied to the channel to render the measured polarization states substantially equal to a desired polarization state, such as that of the band center frequency S₀(ω₀). The compensation process (Step 112) involves the determination of one PMD compensation vector for each compensator present in the system, and the subsequent configuration of the compensator to implement the PMD compensation vector. The magnitude of the compensation vectors may be constant, as in the case of a fixed-delay line, or they may vary, as in the case of a variable-delay line. Variable delay lines add the magnitude of the PMD vectors as extra variables to the optimization computation discussed below, expanding the optimization space for the final optimization or requiring additional degrees of freedom in a look-up table. The principles of the present invention encompass compensation of an arbitrarily high order, such as third-order and fourth-order compensation. Therefore, although the following discussion focuses on second-order compensation for purposes of explanation, the scope of the present invention is not so limited.

In one embodiment providing second order compensation, two PMD vectors Ω₁ and Ω₂ are determined that substantially reduce the difference between the desired polarization state and the polarization states of the channel measured at the various frequencies spanning the channels' waveband. In one embodiment, computing the compensation vectors corresponds to minimizing the integral of the difference between the polarization states across the compensated waveband and the desired polarization state:

$${Ω}_{1} , {Ω}_{2} ∋ {min}_{{Ω}_{1} , {Ω}_{2}} {\int }_{\vert ω \vert \leq BW} {\vert {ⅇ}^{ω {Ω}_{2}^{x}} {ⅇ}^{{ωΩ}_{1}^{x}} {ⅇ}^{{ωΩ}^{x}} {S}_{0} - {S}_{0} \vert}^{2} ⅆ ω \qquad ( Eq . 11 )$$

This integral is simplified computationally in one embodiment to a sum of differences at those frequencies measured by the polarimeter in the measurement step 100:

$${Ω}_{1} , {Ω}_{2} ∋ {min}_{{Ω}_{1} , {Ω}_{2}} {\sum }_{k} {\vert {ⅇ}^{{ω}_{k} {Ω}_{2}^{x}} {ⅇ}^{{ω}_{k} {Ω}_{1}^{x}} {ⅇ}^{{ω}_{k} {Ω}^{x}} {S}_{0} - {S}_{0} \vert}^{2} \qquad ( Eq . 12 )$$

The results of these computations may be precalculated for later use. First, a range of characteristic PMD vector values (i.e., Ω_{fit}) and a range of characteristic DGD values (i.e., τ) are selected. Next, compensation vectors are calculated for various pairs of (Ω_{fit}, τ). The resulting compensation vectors, e.g., Ω₁ and Ω₂ in an embodiment with two-stage compensation, are stored. In higher-order embodiments, the appropriate number of compensation vectors are computed and stored.

The compensation vectors for the (Ω_{fit}, τ) pairs may be stored as, for example, a look-up table. Once retrieved, these precomputed values may be used as the starting condition for a local optimization using Equations 11 or 12, with the directions of the PMD vectors in Poincaré space as the independent variables. Using Equation 11 or 12, a retrieved starting condition, and the measured polarization state data, it is possible to use an optimization routine to determine a higher-order compensation solution. Several techniques exist for such optimization, such as the well-known Levenberg-Marquardt algorithm.

Having determined compensation vectors (e.g., Ω₁ and Ω₂), either in real time or off-line, the compensation vectors may be converted into a form appropriate to the compensating apparatus. For example, when the compensators are polarization controllers combined with delay lines or polarization-maintaining fiber, the compensation vectors may be converted into rotation Muller matrices. In an embodiment with second-order compensation, these matrices are determined using the equations:

$$\begin{matrix}{Ω}_{1} = {R}_{PC1} [ \begin{matrix}0 \\ 0 \\ 1\end{matrix} ] & ( Eq . 13 ) \\ {Ω}_{2} = {R}_{PC1} {R}_{PC2} [ \begin{matrix}0 \\ 0 \\ 1\end{matrix} ] & ( Eq . 14 )\end{matrix}$$

where R_{PC1} and R_{PC2} represent the rotation matrices in Poincaré space for the first and second polarization controllers, respectively. After these two equations are solved, the values of the rotation matrices R_{PC1} and R_{PC2} may be used to determine the polarization settings for the individual retarder elements of the polarization controllers.

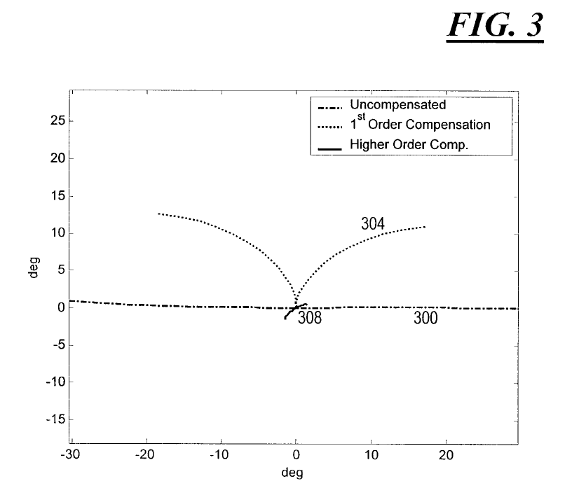

FIG. 3 illustrates the benefit realized from utilizing the higher-order compensation techniques of the present invention compared to compensation techniques that assume the frequency independence of the PMD in the channel. FIG. 3 is a two-dimensional projection of the compensated and uncompensated polarization state measurements as they appear on a Poincaré sphere. The uncompensated polarization state measurements 300 illustrate the frequency-dependence of the PMD in the channel. When first-order, i.e. frequency-independent, compensation is applied to the same set of polarization states, compensated polarization values 304 are the result. It is apparent that while PMD in the channel is reduced by this compensation, it is not fully eliminated. When second-order, i.e. frequency-dependent, compensation is applied in accord with the principles of the present invention, compensated polarization values 308 are the result. It is apparent that higher-order compensation renders the Stokes vectors at various measured frequencies in the channel substantially equal. Similarly improved results will occur from the use of higher-order techniques, such as third-order and fourth-order compensation.

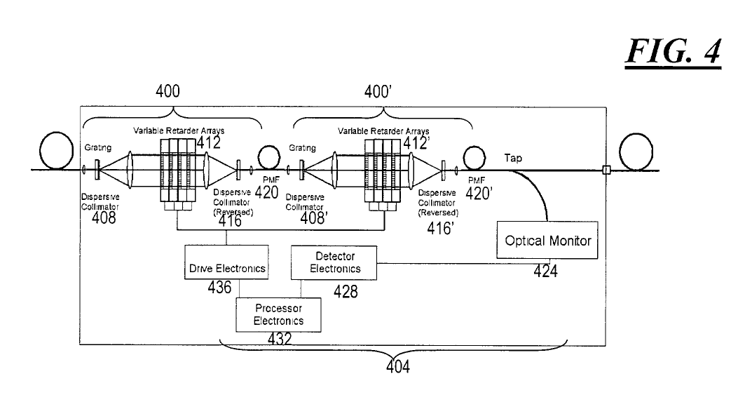

FIG. 4 presents an apparatus for second-order PMD compensation in accord with the present invention. Each delay stage 400, 400′ provides a single stage of PMD compensation. The delay stages 400, 400′ are in communication with a controller stage 404 that measures the resultant spectrally-resolved Stokes vector data after the delay stages and provides control impulses to the polarization controllers in the delay stages. In accord with the principles of the present invention, higher-order PMD compensation may be achieved by adding additional delay stages or their equivalent.

In the embodiment of FIG. 4, each delay stage includes a demultiplexer 408, 408′ a polarization controller 412, 412′ for each channel, a multiplexer 416, 416′ and a common delay line 420, 420′. The demultiplexer 408, 408′ receives an incident light, typically containing a plurality of communication channels, and disperses the channels spatially. Spatial dispersion of the communication channels enables simultaneous processing of multiple channels using parallel arrangements of equipment. For example, in this embodiment, the output of the demultiplexer 408 is provided to a parallel array of polarization controllers 412, 412′—one for each channel. The polarization controllers 412, 412′ are capable of varying the polarization state of each communication channel before recombination by the multiplexer 416 for transmission over the common delay line 420. Typically these controllers receive their settings from the controller module 404, which determines the required corrections as discussed above.

The demultiplexers 408, 408′ and the multiplexers 416, 416′ may be, for example, dispersive collimators, one in a forward orientation and one in a reverse orientation. Typical polarization controllers 412 include variable retarder arrays. The delay line 420 may be, for example, a polarization-maintaining fiber, a free space delay including polarizing beamsplitters and two mirrors, or a birefringent crystal between collimators, depending upon the embodiment.

In this embodiment, the controller stage 404 includes an optical monitor 424, a detector electronics module 428, a processor electronics module 432, and a polarization controller drive electronics module 436.

The optical monitor 424 samples the signal traffic after it has passed through delay stages 400, 400′. Optical monitor 424 measures the intensity of the sampled light and provides intensity measurements to detector electronics 428. In other embodiments, the optical monitor 424 samples the signal traffic between the compensation stages, before the first compensation stage, or before or after either polarization controller. Detector electronics 428 convert the intensity measurements into polarization state measurements, which it provides, in turn, to processor electronics module 432. One embodiment of optical monitor 424 and detector electronics 428 is the polarimeter described in pending U.S. patent application Ser. No. 10/218,681, the entire disclosure of which is incorporated by reference as if set forth in its entirety herein. Processor electronics module 432 applies the higher-order compensation algorithm described above, generating the appropriate parameter settings for application to the polarization controllers 412, 412′ (via drive electronics module 436) to substantially reduce the effects of PMD in the communication channel. The higher-order compensation algorithm may be implemented in software, hardware, or a combination thereof. Processor electronics module 432 may be one or more specialized electronic components, such as application-specific integrated circuits (ASICs), digital signal processors (DSPs), or field-programmable gate arrays (FPGAs), or a general-purpose computing device including a memory and a processor.

Many alterations and modifications may be made without departing from the spirit and scope of the invention. Therefore, it is to be understood that these embodiments have been shown by way of example and should not be taken as limiting the invention, which is defined by the following claims. These claims are thus to be read as not only including literally what is set forth by the claims but also to include those equivalents which are insubstantially different, even though not identical in other respects to what is shown and described in the above illustrations.

What is claimed is:

1. A method of correcting for polarization mode dispersion in a light signal having at least one communication channel, the method comprising:
(a) determining polarization states of the light signal at a plurality of frequency subbands in the communication channel;
(b) determining a characteristic polarization mode dispersion vector using the determined polarization states;
(c) determining a characteristic differential group delay; and
(d) determining, from the characteristic differential group delay, at least two compensation settings which, when applied to the light signal, renders the polarization states of the light signal across the plurality of frequency subbands in the communication channel substantially equal.

2. The method of claim 1 wherein the determined polarization states are Stokes vectors.

3. The method of claim 1 wherein the determined polarization states are Jones vectors.

4. The method of claim 1 further comprising:
(e) applying the determined compensation settings to the light signal using a corresponding number of compensation stages.

5. The method of claim 1 wherein step (b) comprises:
(b-1) constructing a set of vectors from the determined polarization states.

6. The method of claim 5 wherein step (b) further comprises:
(b-2) constructing a set of frequency-dependent polarization mode dispersion vectors from the constructed vectors of step (b-1).

7. The method of claim 6 wherein step (b) further comprises:
(b-3) determining the characteristic polarization mode dispersion vector from the vectors of step (b-2).

8. The method of claim 7 wherein the characteristic polarization mode dispersion vector substantially satisfies a least-squares fit to the determined vectors of step (b-2).

9. The method of claim 1 wherein step (c) comprises:
(c-1) determining the characteristic differential group delay using a second-order fit to the determined polarization states of the light as a function of frequency.

10. The method of claim 1 wherein step (c) comprises:
(c-1) determining the differential group delay using the magnitude of the characteristic polarization mode dispersion vector.

11. The method of claim 1 wherein step (d) comprises:
(d-1) selecting a target polarization state value; and
(d-2) determining the compensation settings such that, when the compensation settings are applied to the light signal, the difference between the selected target polarization state value and the polarization states of the light across the plurality of frequency subbands in the communication channel is substantially reduced.

12. The method of claim 11 wherein the selected target polarization state value is the polarization state value at the band center frequency.

13. The method of claim 1 wherein at least one of the compensation settings varies in magnitude.

14. The method of claim 1 wherein step (d) comprises:
(d-1) retrieving at least one compensation setting using the results of steps (b) and (c) from a memory comprising predetermined compensation settings.

15. The method of claim 14 wherein step (d) further comprises:
(d-2) utilizing the at least one retrieved compensation setting as an input to an optimization routine; and
(d-3) using the result of the optimization routine as at least one of the compensation settings.

16. The method of claim 15 wherein the optimization routine is the Levenberg-Marquardt algorithm.

17. The method of claim 4 wherein step (e) comprises:
(e-1) computing rotation Mueller matrices for polarization controllers corresponding to the determined compensation settings.

18. The method of claim 1 wherein steps (a)-(d) are applied to a plurality of communication channels in the light signal at substantially the same time.

19. An apparatus for correcting polarization mode dispersion in a light signal having at least one communication channel, the apparatus comprising:
a polarization state detector for receiving the light signal and providing polarization state measurements thereof at a plurality of frequency subbands in the communication channel;
a first compensator for receiving the light signal and imposing a first differential group delay thereon; and
a second compensator for receiving the light signal from the first compensator and imposing a second differential group delay thereon,
wherein the first differential group delay and the second differential group delay are determined from the polarization state measurements so as to reduce the polarization mode dispersion effects on the light signal.

20. The apparatus of claim 19 wherein at least one of the first and second compensators comprises:
a plurality of polarization controllers, each of the polarization controllers being associated with a particular communication channel.

21. The apparatus of claim 20 further comprising:
a demultiplexer in series with the plurality of polarization controllers;
a multiplexer in series with the plurality of polarization controllers; and
a common delay line in series with the multiplexer.

22. The apparatus of claim 21 wherein the common delay line is a polarization-maintaining fiber.

23. The apparatus of claim 22 wherein the common delay line comprises a free space delay including a first polarizing beam splitter, a second polarizing beam splitter, a first mirror, and a second mirror.

24. The apparatus of claim 22 wherein the common delay line includes a first collimator, a second collimator, and a birefringent crystal situated between the first collimator and the second collimator.
